(19) United States
(12) Patent Application Publication
(10) Pub. No.: US 2022/0196278 A1
(43) Pub. Date: Jun. 23, 2022

(54) AIR-CONDITIONING MANAGEMENT APPARATUS AND AIR-CONDITIONING SYSTEM

(71) Applicant: Mitsubishi Electric Corporation, Tokyo (JP)

(72) Inventor: Kento NISHITSUJI, Tokyo (JP)

(21) Appl. No.: 17/603,449

(22) PCT Filed: May 14, 2019
(86) PCT No.: PCT/JP2019/019146

§ 371 Date: Oct. 13, 2021

(51) Int. Cl. F24F 11/63

(52) U.S. Cl. CPC F24F 11/63; F24F 2120/10

(57) ABSTRACT

An air-conditioning management apparatus for managing an air-conditioning apparatus having an indoor unit for air-conditioning an air-conditioning target space is provided. The air-conditioning management apparatus includes a schedule information acquisition unit that acquires data of schedule information sent from a schedule management system having a schedule for a facility in which the air-conditioning apparatus is installed; a human detection information acquisition unit that acquires human detection information data related to detection of a human detection sensor, the human detection sensor being configured to detect presence or absence of a human in the air-conditioning target space in which the indoor unit is located; and a learning unit that performs a learning process to associate contents of the schedule with the indoor unit corresponding to the human detection sensor based on the data of schedule information and the human detection information data.

### CROSS REFERENCE TO RELATED APPLICATION

This application is a U.S. national stage application of International Patent Application No. PCT/JP2019/019146 filed on May 14, 2019, the disclosure of which is incorporated herein by reference.

### TECHNICAL FIELD

The present disclosure relates to an air-conditioning management apparatus and an air-conditioning system. In particular, it relates to mapping of a schedule to an indoor unit.

### BACKGROUND

There are conventional air-conditioning systems that perform air-conditioning in conjunction with a schedule management system that manages the reservation status of a facility. For example, the air-conditioning management apparatus of the air-conditioning system obtains data on a time slot when each room in the facility is used from data stored in the schedule management system. Then, based on the acquired data, the air-conditioning management system performs preliminary operation according to the time slot when the rooms are in use, and controls the operation by stopping it during the time when the rooms are not in use. This improves the comfort of room users and saves energy (see, for example, Patent Literature 1).

An air-conditioning system that performs more precise air-conditioning control by using data obtained from various sensors and the like, in addition to data from the schedule management system, has also been proposed (see, for example, Patent Literature 2 and Patent Literature 3).

### Patent Literature

Patent Literature 1: Japanese Unexamined Patent Application Publication No. 2013-089208

Patent Literature 2: Japanese Patent No. 2981318

Patent Literature 3: Japanese Patent No. 4274157

In the conventional technology for air-conditioning systems, there is no mechanism for automatically mapping the indoor unit to the data related to the schedule in the schedule management system. Therefore, when the air-conditioning system is installed in a facility, the correspondence between the schedule information and the indoor unit has to be registered manually. As a result, there were problems in terms of time and cost, such as more time and effort required for installation and the possibility of errors.

### SUMMARY

An object pursued in the air-conditioning management system of the present disclosure is to obtain an air-conditioning management apparatus and an air-conditioning system capable of automatically mapping schedule-related data and an indoor unit to overcome the above problems.

The air-conditioning management apparatus of the present disclosure is an air-conditioning management apparatus for managing an air-conditioning apparatus having an indoor unit for air-conditioning an air-conditioning target space, the air-conditioning management apparatus including a process controller including: a schedule information acquisition unit that acquires data of schedule information sent from a schedule management system having a schedule for a facility in which the air-conditioning apparatus is installed; a human detection information acquisition unit that acquires human detection information data related to detection of a human detection sensor, the human detection sensor being configured to detect presence or absence of a human in the air-conditioning target space in which the indoor unit is located; and a learning unit that performs a learning process to associate contents of the schedule with the indoor unit corresponding to the human detection sensor based on the data of schedule information and the human detection information data.

The air-conditioning system of the present disclosure is provided with an air-conditioning management apparatus as described above and an air-conditioning apparatus having an indoor unit which is controlled by the air-conditioning management apparatus and which performs air-conditioning of an air-conditioning target space.

According to the present disclosure, the learning unit of the process controller performs a learning process to associate the relationship between the schedule information managed by the schedule management system and the human detection sensor with each other. Therefore, it is not necessary to manually input the correspondence between the schedule and the indoor unit. Therefore, it is possible to reduce the time and cost associated with the mapping of schedules and indoor units. In addition, the air-conditioning apparatus can be controlled in conjunction with the schedule management system.

### BRIEF DESCRIPTION OF DRAWINGS

FIG. 1 shows, as a primary element, an air-conditioning system having an air-conditioning management apparatus in Embodiment 1.

FIG. 2 illustrates the flow of processing regarding information acquisition performed by the air-conditioning management apparatus according to Embodiment 1.

FIG. 3 shows the contents of the schedule information included in a signal sent from the schedule management system 2 according to Embodiment 1.

FIG. 4 shows the contents of the human detection information contained in a signal sent from the human detection sensors according to Embodiment 1.

FIG. 5 is a flowchart illustrating an example of a learning process performed by a learning unit according to Embodiment 1.

FIG. 6 is a flowchart for describing a process relating to operation control performed by the air-conditioning management apparatus according to Embodiment 1.

FIG. 7 shows, as a primary element, an air-conditioning system having an air-conditioning management apparatus in Embodiment 2.

### DETAILED DESCRIPTION

In the following, the air-conditioning management apparatus and the like according to embodiments will be described with reference to the drawings and other parts of the documents. In the following drawings, components marked with the same sign are the same as or equivalent to each other, and this will be common throughout the embodiments described below. Also, in the drawings, the size relationships between the components may differ from the actual ones. The forms of the components represented throughout the specification are only examples, and possible forms of the components are not to limit those described in the specification. It may not be necessary to include all of the devices described in the specification. In particular, the combination of components is not limited only to the combination in each embodiment, and components described in one embodiment may be applied to another embodiment. The highs and lows of pressure and temperature are not determined in relation to absolute values in particular, but are determined relative to the state and operation of the device, etc. In addition, when there is no need to specifically distinguish or specify a plurality of the same type of devices, etc., which are distinguished by signs, subscripts, etc., such signs, subscripts, etc. may be omitted.

### Embodiment 1

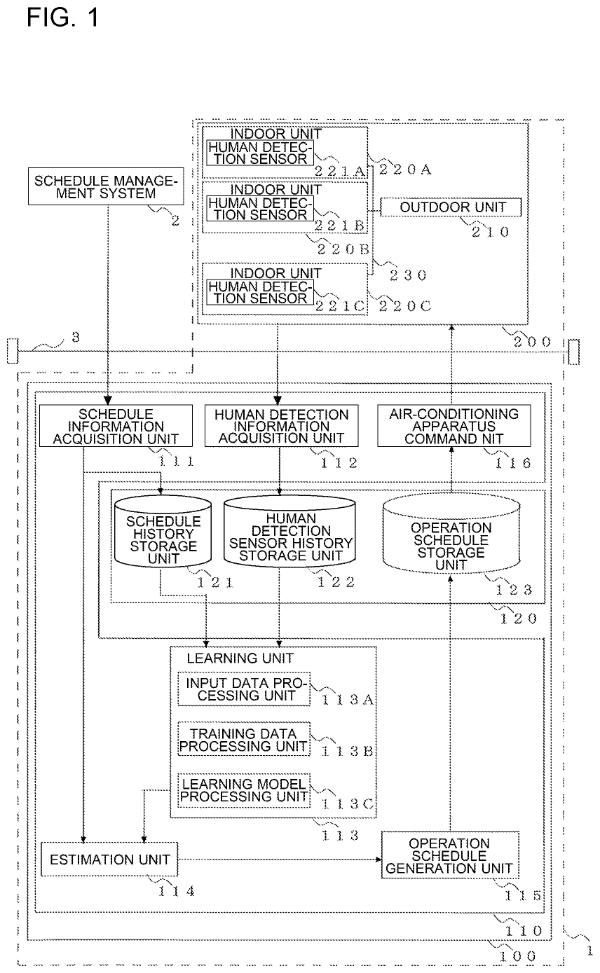

FIG. 1 shows, as a primary element, an air-conditioning system having an air-conditioning management apparatus in Embodiment 1. As shown in FIG. 1, the air-conditioning system 1 is communicably connected to a schedule management system 2 via an electric communication line 3. Therefore, the air-conditioning system 1 can obtain the data of schedule information for the use of facilities based on the signal sent from the schedule management system 2.

The air-conditioning system 1 has an air-conditioning management apparatus 100 and an air-conditioning apparatus 200. The air-conditioning apparatus 200 is installed in a facility to be air conditioned. In the air-conditioning apparatus 200, an outdoor unit 210 and a plurality of indoor units 220 are connected by pipes to form a refrigerant circuit that circulates refrigerant. In FIG. 1, three indoor units 220 (an indoor unit 220A, an indoor unit 220B, and an indoor unit 220C) are connected to the outdoor unit 210 by refrigerant pipes 230.

The outdoor unit 210 has a compressor, an outdoor heat exchanger, and other equipment (not shown), and supplies heat to the indoor units 220 by refrigerant. The plurality of indoor units 220 are each installed in an air-conditioning target space, and perform air-conditioning of the air-conditioning target space. Each indoor unit 220 has a device (not shown) such as an indoor heat exchanger, and transfers heat transferred by the refrigerant to the air in the air-conditioning target space, for example, to heat or cool the air in the air-conditioning target space. In addition, each indoor unit 220 is equipped with a human detection sensor 221 (a human detection sensor 221A, a human detection sensor 221B, and a human detection sensor 221C). The human detection sensor 221 is a detection device that detects, for example, the presence or absence of a human in the air-conditioning target space by detecting a physical quantities of, for example, infrared rays. Here, the description is such that the indoor unit 220 has the human detection sensor 221, but the present disclosure is not limited thereto, and it is sufficient if the sensor is installed in a location where the sensor can detect a human in the air-conditioning target space in which the indoor unit 220 is located, such as in the vicinity of the indoor unit 220.

The air-conditioning management apparatus 100 collects data concerning the air-conditioning apparatus 200 to be controlled. The air-conditioning management apparatus 100 generates an operation schedule of the air-conditioning apparatus 200 based on the collected data. Then, the air-conditioning management apparatus 100 controls the air-conditioning apparatus 200 based on the operation schedule. The air-conditioning management apparatus 100 has a process controller 110 and a data storage device 120.

The data storage device 120 stores various data for the process controller 110 to perform processing. The data storage device 120 of Embodiment 1 has a schedule history storage unit 121, a human detection sensor history storage unit 122, and an operation schedule storage unit 123. The schedule history storage unit 121 stores, as data, schedule information acquired and processed by the schedule information acquisition unit 111 described below. The human detection sensor history storage unit 122 stores, as data, human detection information acquired and processed by the human detection information acquisition unit 112 to be described later. The operation schedule storage unit 123 stores as data the operation schedule generated by the operation schedule generating unit 115 to be described later. Here, in the air-conditioning management apparatus 100 of Embodiment 1, the data storage device 120 collectively stores the data used for processing by the process controller 110. However, in the air-conditioning management apparatus 100, the schedule history storage unit 121, the human detection sensor history storage unit 122, and the operation schedule storage unit 123, etc., may be comprised of storage devices independent from one another.

The process controller 110 controls the air-conditioning apparatus 200 based on the operation schedule of the air-conditioning apparatus 200 generated based on the usage schedule for the air-conditioning target space in which each indoor unit 220 is installed and the detection by the human detection sensor 221, etc.

The schedule information acquisition unit 111 acquires and processes the schedule information of facility users as data based on signals sent from the schedule management system 2, and stores it in the schedule history storage unit 121 of the data storage device 120. In addition, the human detection information acquisition unit 112 performs a process of acquiring and processing data of human detection information such as the detection of human or number of humans detected based on signals sent from the human detection sensors 221 mounted on each indoor unit 220, and storing the data in the human detection sensor history storage unit 122 of the data storage device 120.

The learning unit 113 executes a learning algorithm to perform a learning process based on the schedule information and the data of human detection information to associate the schedule information with the indoor unit 220 equipped with the human detection sensor 221. The learning unit 113 has an input data processing unit 113A, a training data processing unit 113B, and a learning model processing unit 113C. The input data processing unit 113A generates input data based on the data of schedule information. The training data processing unit 113B generates training data based on the data of human detection information. Then, the learning model processing unit 113C performs the learning process based on the input data and the training data. The processing of the learning unit 113 will be described later. The estimation unit 114 performs estimation processing regarding the presence or absence of a human at each time slot in the air-conditioning target space in which the indoor unit 220 is located from the schedule information for the upcoming schedule based on the learning results of the learning processing by the learning unit 113. The operation schedule generating unit 115 performs processing of generating data of the operation schedule for the air-conditioning apparatus 200 based on the estimation processing results of the estimation unit 114, and storing the operation schedule data in the operation schedule storage unit 123.

The air-conditioning apparatus commanding unit 116 sends a signal to the air-conditioning apparatus 200 based on the data of the operation schedule stored in the operation schedule storage unit 123, and controls the operation of the air-conditioning apparatus 200.

Here, the process controller 110 comprises, as hardware, a server and a microcomputer having, for example, a control and arithmetic processing unit such as a CPU (Central Processing Unit), an analog circuit, a digital circuit, and the like. The data storage device 120 comprises, for example, a volatile storage device (not shown) such as a random access memory (RAM) that can temporarily store data, and a non-volatile auxiliary storage device (not shown) such as a hard disk that can store data on a long-term basis.

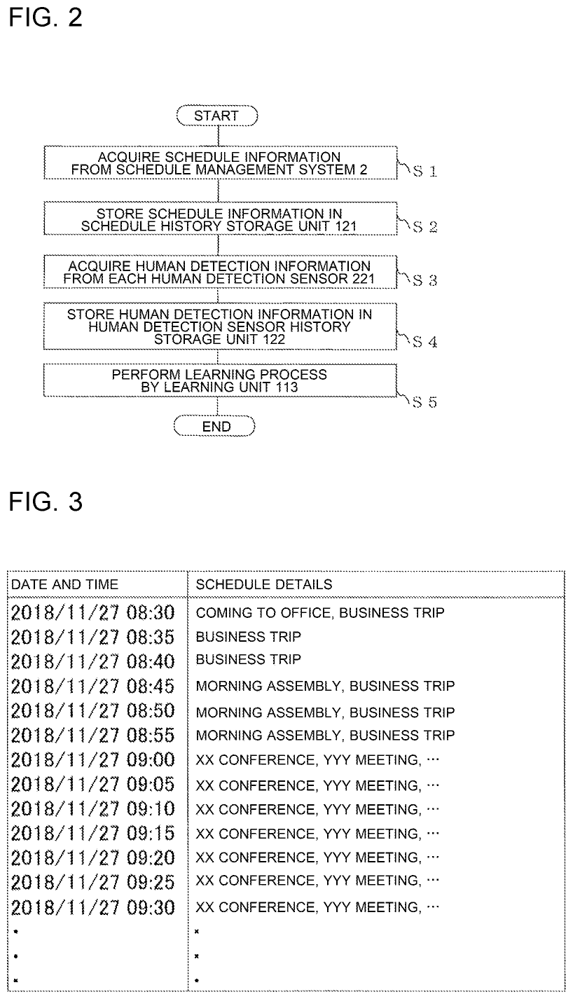

FIG. 2 illustrates the flow of processing regarding information acquisition performed by the air-conditioning management apparatus according to Embodiment 1. Based on FIG. 1 and FIG. 2, the processing performed by the air-conditioning management apparatus 100 will be described. The following description assumes that each part of the process controller 110 performs its own processing.

The schedule information acquisition unit 111 of the process controller 110 requests schedule information from the schedule management system 2. Based on the signal sent from the schedule management system 2, the schedule information acquisition unit 111 acquires the data of schedule information related to the facility user and included in the signal (Step S1). Then, the schedule information acquisition unit 111 stores the acquired data of schedule information in the schedule history storage unit 121 (Step S2). Here, the schedule information acquisition unit 111 requests schedule information from the schedule management system 2, but this is not a limitation. The schedule information acquisition unit 111 may process signals sent periodically from the schedule management system 2.

The human detection information acquisition unit 112 of the process controller 110 acquires data of human detection information based on signals sent from the human detection sensors 221 included in the indoor units 220 (Step S3). The human detection information acquisition unit 112 stores the acquired data of human detection information in the human detection sensor history storage unit 122 (Step S4). Here, the description herein explained the case of acquiring and storing the schedule information, and then acquiring and storing the human detection information, but the order of acquiring and storing the information is not limited.

The learning unit 113 performs a learning process based on the data of the schedule information for the past stored in the schedule history storage unit 121 and the data of human detection information stored in the human detection sensor history storage unit 122 in the same time slot (Step S5). Through the learning process, the learning unit 113 calculates the weight parameter A and the bias parameter B to be used when the estimation unit 114 performs the estimation process, as described below.

FIG. 3 shows the contents of the schedule information included in a signal sent from the schedule management system 2 according to Embodiment 1. The signal sent from the schedule management system 2 includes data of schedule information that associates the date and time with the schedule contents of all users of the facility. In

FIG. 3, the date and time of the schedule are set at five-minute intervals. The schedule contents are listed as the contents of the facility users' schedules. For example, the schedules of several people with the same contents are combined into one.

In the schedule information in FIG. 3, for example, for the date and time of 8:30 on Nov. 27, 2018, either “coming to office” or “business trip” is written as the schedule content of the facility user. Also, for example, at 9:05 on Nov. 27, 2018, either “XX conference” or “YYY meeting” is noted as the facility user's schedule.

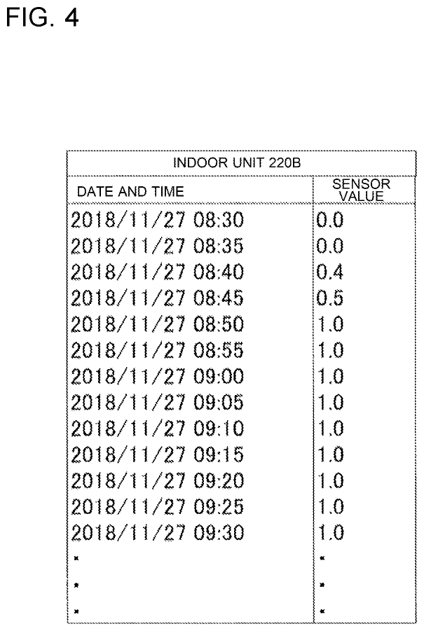

FIG. 4 shows the contents of the human detection information contained in a signal sent from the human detection sensors according to Embodiment 1. The signal sent from each human detection sensor 221 contains data in which the date and time are associated with the sensor value. In FIG. 4, the date and time are set at five-minute intervals. The sensor value is a numerical value that indicates the certainty of detecting a human by the human detection sensor 221, and is a value in the range of 0.0 to 1.0. The higher the value, the higher the probability that a human is present. For example, the presence or absence of a human can be determined by setting a threshold value.

In FIG. 4, for example, the human detection sensor 221B of indoor unit 220B detects a sensor value of 0.0 at 8:30 on Nov. 27, 2018. Also, at 9:05 on Nov. 27, 2018, the sensor value detects 1.0.

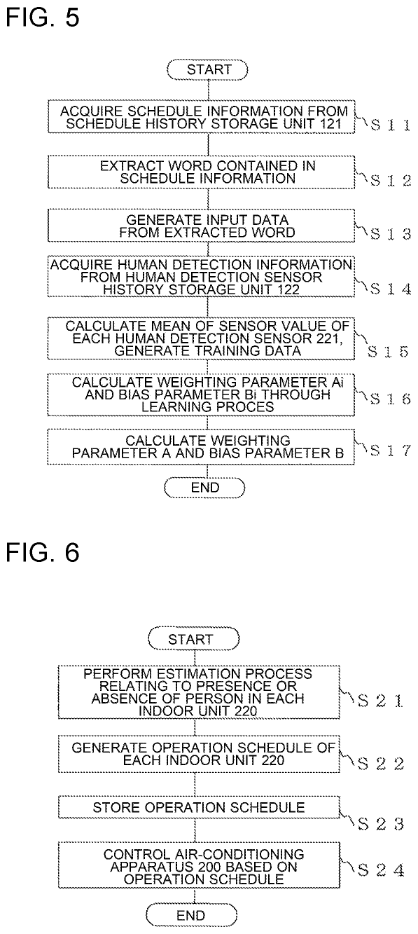

FIG. 5 is a flowchart illustrating an example of a learning process performed by a learning unit according to Embodiment 1. Based on FIG. 1 and FIG. 5, the learning process performed by the learning unit 113 will be described. In the learning process, the learning unit 113 uses the data of schedule information stored in the schedule history storage unit 121 as input data for the learning model. In addition, the learning unit 113 uses the data of sensor value information stored in the human detection sensor history storage unit 122 as training data for the learning model.

The input data processing unit 113A of the learning unit 113 reads the schedule information of the time unit to be learned from the schedule history storage unit 121 (Step S11). Here, the time unit is, for example, 30 minutes, 1 hour, etc. Then, the input data processing unit 113A extracts all the words contained in the schedule information for the time slot to be learned (Step S12). The input data processing unit 113A generates the input data, which is vectors of the extracted words (Step S13). The method of extracting words and vectorizing words is not particularly limited. For example, the N-gram method is used in which words are extracted by breaking down the string into one or more characters. As for the method of vectorizing words, there are methods using distributed representation such as Word2Vec.

Assuming that vn is the vectorized n-th word contained in the schedule information for the time slot to be learned, the input data in the learning unit 113 is represented by Formula (1). Here, the order of the words is not limited.

[Formula 1]

[v1, v2, v3, . . . , vn] (1)

The training data processing unit 113B of the learning unit 113 reads the sensor value information of each human detection sensor 221 in the time unit to be learned from the human detection sensor history storage unit 122 (Step S14). Then, the training data processing unit 113B calculates the average value of the sensor values of each human detection sensor 221 in the time unit (Step S15). Where the average value of the sensor values in the human detection sensor 221 of number m is xm, the training data in the learning unit 113 can be represented by the vector shown in Formula (2).

[Formula 2]

[x1, x2, x3, . . . , xm] (2)

The learning model processing unit 113C performs the learning process based on the input data generated by the input data processing unit 113A and the training data generated by the training data processing unit 113B. Here, the learning model processing unit 113C performs processing based on a multilayer neural network having an input layer that matches the dimensions of the input data, an output layer that matches the dimensions of the training data, and one or more hidden layers between the input layer and the output layer.

Let Xi be a vector of values for each layer, which can be expressed as a formula shown in equation (3). For example, if the learning model consists of three layers, i=1 is the input layer, i=2 is the hidden layer, and i=3 is the output layer. And Ai is the weight parameter in layer i, represented by a matrix. Bi is the bias parameter in layer i, represented as a vertical vector. And f is an activation function, such as a sigmoid function.

[Formula 3]

Xi=f(AiXi+Bi) (3)

The learning model processing unit 113C calculates the weight parameter Ai and the bias parameter Bi through a learning process (Step S16). The weight parameter Ai and the bias parameter Bi for the output layer calculated by the learning model processing unit 113C are the weight parameter A and the bias parameter B used for the estimation process in the estimation unit 114. The learning model processing unit 113C eventually calculates the weight parameters A and bias parameters B by computing the weight parameters Ai and bias parameters Bi (Step S17). For example, when the input layer is about three dimensions, such as when there are three words input as data at a time, the weight parameter A is a matrix with three rows and three columns.

For example, based on FIG. 3 and FIG. 4, the learning unit 113 can learn that the words “XXX”, “conference”, “YYY”, or “meeting” contained in the schedule information and the sensor values of the human detection sensor 221B included in the indoor unit 220B are highly related. Therefore, when there is a schedule that includes the words “XXX”, “conference”, “YYY” and “meeting”, the learning unit 113 calculates the weight parameter A and the bias parameter B that indicate that there is a high possibility that there is a human in the air-conditioning target space in which the indoor unit 220B is located. Thus, for example, the space where the XXX conference and the YYY meeting are held can be mapped as the air-conditioning target space of the indoor unit 220B.

FIG. 6 is a flowchart for describing a process relating to operation control performed by the air-conditioning management apparatus according to Embodiment 1. The air-conditioning management apparatus 100 of Embodiment 1 generates an operation schedule based on the presence or absence of a human in the air-conditioning target space of each indoor unit 220 estimated based on the schedule information. Then, the air-conditioning management apparatus 100 controls the air-conditioning apparatus 200 based on the data of the generated operation schedule.

The estimation unit 114 performs an estimation process for the presence or absence of a human at each time slot of the air-conditioning target space of each indoor unit 220 based on the weight parameter A and the bias parameter B, which are learning results of the learning unit 113, and the schedule information for the upcoming schedule (Step S21). The estimation unit 114 estimates and calculates the sensor values to be detected by the human detection sensor 221 that each indoor unit 220 has, based on, for example, the words contained in the schedule information for the scheduled use. Here, in the estimation unit 114, as in the learning unit 113, processing based on, for example, a neural network is performed from the data generated by extracting words included in the schedule information. The estimation unit 114 then compares the estimated sensor value with a predetermined threshold value and processes the estimation of the presence or absence of a human. For example, as expressed in the following equation (4), when the threshold value is set to 0.5 for the sensor value estimated to be detected by each human detection sensor 221, the estimation unit 114 can estimate that there is a human in the air-conditioning target space in which the indoor unit 220B having the human detection sensor 221B is located.

[Formula 4]

[x1, x2, x3]=[0, 0.9, 0.1] (4)

The operation schedule generating unit 115 generates an operation schedule for each indoor unit 220 based on the estimation results estimated by the estimation unit 114 (Step S22). As for the operation schedule, for example, for the indoor unit 220 in the air-conditioning target space that is estimated to have a human during a certain time slot, an operation schedule is generated to perform preliminary operation at the time slot. For the indoor unit 220 that is located in an air-conditioning target space estimated to be unoccupied over a certain time slot, an operation schedule is generated to turn OFF the operation of the indoor unit 220 during that time slot. The operation schedule generating unit 115 stores the data of the generated operation schedule in the operation schedule storage unit 123 (Step S23).

The air-conditioning apparatus commanding unit 116 sends operation commands to the outdoor unit 210 and the indoor units 220 based on the operation schedule data stored in the operation schedule storage unit 123, and controls the air-conditioning apparatus 200 (Step S24).

As described above, the process controller 110 of the air-conditioning management apparatus 100 of Embodiment 1 acquires the schedule information sent from the schedule management system 2 and the human detection information related to the detection of the human detection sensor 221 that each indoor unit 220 has. Then, the learning unit 113 of the process controller 110 learns the correspondence between the words of the schedule contents included in the schedule information and the sensor values of each human detection sensor 221 included in the human detection information. As a result, it is possible to map the contents of the schedule included in the schedule information to the presence or absence of a human in the air-conditioning target space in which the indoor unit 220 is located without manual input or the like.

Then, according to the air-conditioning management apparatus 100 of Embodiment 1, the estimation unit 114 estimates the sensor value of the human detection sensor 221 that each indoor unit 220 has for each time slot based on the results learned by the learning unit 113 and the schedule information to be sent from the schedule management system 2. The operation schedule generating unit 115 generates an operation schedule based on the estimated sensor value. Then, the air-conditioning apparatus commanding unit 116 controls the air-conditioning apparatus 200 based on the operation schedule. Therefore, it is possible to control the air-conditioning apparatus 200 in conjunction with the schedule information of the schedule management system 2.

### Embodiment 2

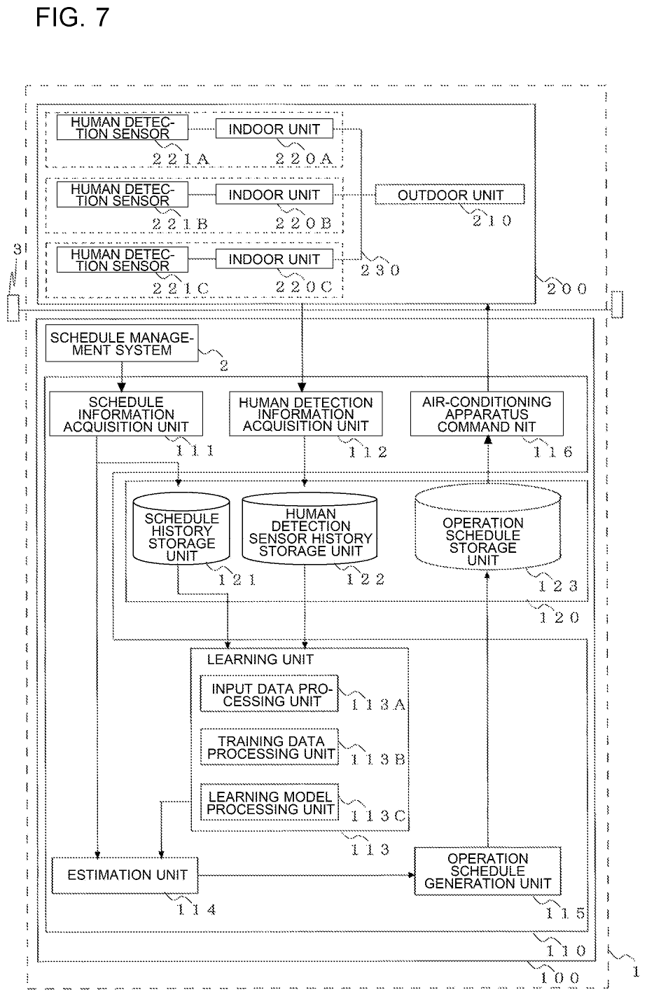

FIG. 7 shows, as a primary element, an air-conditioning system having an air-conditioning management apparatus in Embodiment 2. In the above-described Embodiment 1, the schedule management system 2 is described as a separate system from the air-conditioning system 1, but the configuration is not limited thereto. The schedule management system 2 may be provided within the air-conditioning system 1, and the air-conditioning management apparatus 100 may perform processing related to the schedule management performed by the schedule management system 2.

In the above-described Embodiment 1, the indoor unit 220 is described as having a human detection sensor 221, but the configuration is not limited thereto. As shown in FIG. 7, the human detection sensor 221 may be installed in the air-conditioning target space of the corresponding indoor unit 220; for example, the human detection sensor 221 may be installed in the vicinity of the indoor unit 220.

Furthermore, although the above-described Embodiment 1 does not specifically refer to details of the air-conditioning apparatus 200, the control by the air-conditioning management apparatus 100 described in Embodiment 1 can be applied to various types of air-conditioning apparatus 200 such as multi air-conditioning systems for buildings or central air-conditioning systems which may be existing ones or those which will be provided in the future.

1. An air-conditioning management apparatus for managing an air-conditioning apparatus having an indoor unit for air-conditioning an air-conditioning target space, the air-conditioning management apparatus comprising a process controller comprising:
a process controller configured to
acquire data of schedule information sent from a schedule management system having a schedule for a facility in which the air-conditioning apparatus is installed;
acquire human detection information data related to detection of a human detection sensor, the human detection sensor being configured to detect presence or absence of a human in the air-conditioning target space in which the indoor unit is located;
perform a learning process to associate contents of the schedule with the indoor unit corresponding to the human detection sensor based on the data of schedule information and the human detection information data.

2. The air-conditioning management apparatus of claim 1, further comprising:
a data storage device configured to store data, the data storage device being configured to
store the data of schedule information, and
store the human detection information data wherein
the process controller is configured to perform the learning process based on the data of schedule information stored in the data storage device and the human detection information data stored in the data storage device.

3. The air-conditioning management apparatus of claim 1, wherein the process controller is further configured to perform the learning process related to relationship between words included in the schedule and the sensor values of the human detection sensor.

4. The air-conditioning management apparatus of claim 1, wherein the process controller is further configured to estimate presence or absence of a human in the air-conditioning target space in which the indoor unit is located based on the learning results and the schedule information.

5. The air-conditioning management apparatus of claim 4, wherein the process controller is further configured to generate operation schedule data related to ON and OFF of at least the indoor unit of the air-conditioning apparatus based on the results of the estimation.

6. The air-conditioning management apparatus of claim 5, wherein the data storage device is further configured to store the operation schedule data.

7. The air-conditioning management apparatus of claim 5, wherein the process controller is further configured to control the air-conditioning apparatus based on the operation schedule data.

8. An air-conditioning system comprising:
the air-conditioning management apparatus of claim 1, and
an air-conditioning apparatus including an indoor unit that is controlled by the air-conditioning management apparatus and that performs air-conditioning of an air-conditioning target space.

9. The air-conditioning system of claim 8, wherein a human detection sensor for detecting the presence or absence of a human in the air-conditioning target space in which the indoor unit is located is installed in the indoor unit, or in the air-conditioning target space in which the indoor unit is located.

10. The air-conditioning system of claim 8, further comprising a schedule management system having a schedule for the facility in which the air-conditioning apparatus is installed.

11. The air-conditioning management apparatus of claim 2, wherein the process controller is further configured to perform the learning process related to relationship between words included in the schedule and the sensor values of the human detection sensor.

12. The air-conditioning management apparatus of claim 2, wherein the process controller is further configured to estimate presence or absence of a human in the air-conditioning target space in which the indoor unit is located based on the learning results and the schedule information.

13. The air-conditioning management apparatus of claim 3, wherein the process controller is further configured to estimate presence or absence of a human in the air-conditioning target space in which the indoor unit is located based on the learning results and the schedule information.
